(19) United States
(12) Patent Application Publication
(10) Pub. No.: US 2003/0138569 A1
(43) Pub. Date: Jul. 24, 2003

(54) Wall board compound dispenser with catalyst mixer

(76) Inventor: Daniel Dea Dillinger, Parsons, KS (US)

Correspondence Address: James E. Bradley, BRACEWELL & PATTERSON, LLP, P.O. Box 61389, Houston, TX, 77208-1389, US

(21) Appl. No.: 10/326,002

(22) Filed: Mar. 31, 2003

Related U.S. Application Data
(60) Provisional application No. 60/345,114, filed on Dec. 21, 2001.

(51) Int. Cl. B05D 1/02

(52) U.S. Cl. 427/421; 156/575; 156/577

(57) ABSTRACT

A dispensing tool will mix and dispense viscous material having first and second parts or constituents. The tool has a handheld elongated tube with a nozzle on one end. A blender is located adjacent the nozzle. The first constituent is located within a chamber in the tube. The second constituent is located in a reservoir mounted to the tube. The blender has an inlet receiving first and second constituents and a rotary member for mixing the constituents and delivering them through an outlet to the nozzle. A piston driven by a wheel delivers the first constituent to the blender. The wheel rotates when the nozzle end of the tube is advanced along an application surface, causing the piston to move and the blender to rotate. A pump, also driven by the wheel, supplies a second constituent from the reservoir to the blender.

### FIELD OF THE INVENTION

This invention relates in general to tools for dispensing wall board compound onto walls, and in particular to a tool that so mixes a catalyst with a compound while it is being dispensed to speed up the drying of the compound.

### DESCRIPTION OF THE PRIOR ART

Wall board compound is used to fill joints or gaps between sheets of wall board. The joints are filled by troweling the wall board compound into the joint while simultaneously placing a web of tape on the joint. The compound is a viscous mixture that shrinks while it dries or cures. After drying, the painter sands the compound on the joint and places another layer of compound on it. Several layers must be placed on the joint, with a drying time between each application. The need to wait for drying times between applications slows the total process, even though the painter may be able to work on other tasks while the joint is drying.

A chemical or catalyst is marketed for mixing with a type of compound to speed up the process of drying. The mixing of the catalyst with the compound must be done immediately before application. Once mixed with compound, the mixture must be applied quickly. If the painter has any mixture remaining, it will have to be thrown away. On the other hand, a compound that does not utilize a catalyst may be kept for a relatively long time as long as a lid is placed over the container holding the compound.

Dispensing tools exist for dispensing tape and compound simultaneously. Some types are particularly useful for reaching high areas on a wall. One tool of this type has a tube that is filled with compound and a nozzle on a forward end. A piston, located in the tube, moves along the tube to dispense compound. The movement of the piston is handled by the use of a wheel or roller having serrated edges. The wheel is located adjacent the nozzle and is pushed against the wall for frictional gripping. As the user moves the tool along the wall, the wheel rotates a winch or reel. A line extends from the piston to the reel so that rotation of the wheel causes the reel to take up the line, drawing along the piston.

This tool also will dispense tape, having a tape holder near the proximal end. A web extends along the tube and is dispensed under the wheel. A cutter is located at the head for severing the tape at the conclusion of a stroke. The cutter moves transversely across the web of tape. This transverse movement is handled by a sleeve that is manually reciprocated on the tool. At the same time the sleeve is reciprocated, a tape advance mechanism will advance the tape. While this tool performs the task intended, it does not operate with any type of catalyst. Mixing a catalyst with compound and placing the mixture in the tube would necessitate the operator purging the mixture entirely and cleaning the tool after each use.

### SUMMARY OF THE INVENTION

In this invention, an apparatus is provided that will mix first and second-constituents, such as wall board compound and catalyst, while being dispensed. The apparatus has a handheld elongated member or tube with a nozzle on one end. A blender is carried by the elongated member adjacent the nozzle. The blender has an inlet for receiving a first constituent, such as compound, from a first constituent source, such as the chamber in the elongated member. The blender has an inlet for receiving a second constituent, such as catalyst, from a second constituent source. The blender has a rotary member that mixes the first and second constituents. The blender has an outlet that leads to the nozzle for dispensing the blended first and second constituents.

In the preferred embodiment, the handheld elongated member has a wheel on its nozzle end with a piston in the elongated member that is connected to a reel by a line. Rotating the wheel causes the piston to move toward the nozzle, pushing compound from the chamber. Rotation of the wheel also drives the blender through a drive linkage. Additionally, rotation of the wheel drives a pump to pump the second constituent from a reservoir mounted on the elongated member to the blender. The pump is preferably a peristaltic type that squeezes a flexible tube in cyclic action to cause the catalyst to flow from the catalyst reservoir.

The tool of the preferred embodiment has self-purging features. One purging member comprises a purging piston in the blender that is actuated hydraulically. Another purging member comprises a flexible bladder in the nozzle that is also actuated hydraulically. A hydraulic cylinder mounts to the elongated member. The cylinder is manually actuated by reciprocating an external sleeve on the external member. The sleeve also operates in a conventional manner to drive a cutter across the web to cut the tape. The sleeve also actuates a tape advance mechanism.

### BRIEF DESCRIPTION OF THE DRAWINGS

FIGS. 1A and 1B comprise a side view, partially in section of a dispensing tool constructed in accordance with this invention.

FIG. 2 is a side view of the forward portion of the tool of FIGS. 1A and 1B, and shown on the side opposite of FIG. 1B.

FIG. 3 is a side view of a central portion of the tool of FIGS. 1A nd 1B.

FIG. 4 is a schematic sectional view of the head portion of the tool of FIGS. 1A and 1B.

FIG. 5 is a sectional view of a head portion of the tool of FIGS. 1A and 1B, taken along the line 5-5 of FIG. 4.

FIG. 6 is an exploded view of a catalyst pump for the tool of FIGS. 1A and 1B.

FIG. 7 is a side view of the catalyst pump of FIG. 6.

FIG. 8 is a sectional view of a reel for the line that pulls the compound piston.

### DESCRIPTION OF THE PREFERRED EMBODIMENT

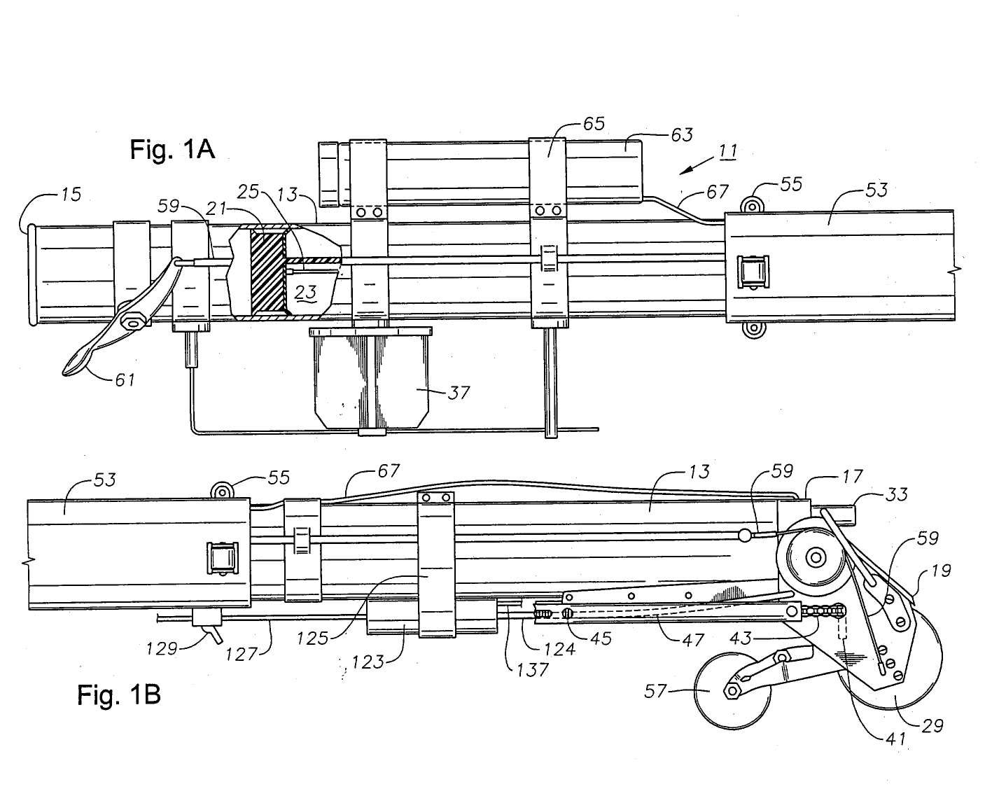

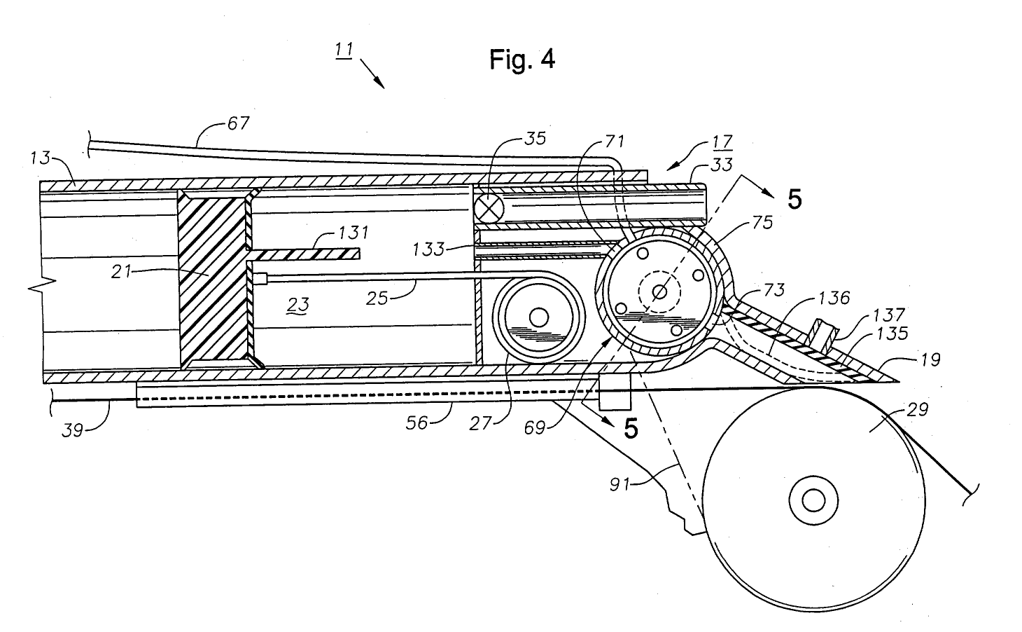

Referring to FIGS. 1A and 1B, dispensing tool 11 has an elongated member or tube 13. Tube 13 is adapted to be held by a user near its proximal end 15. Tube 13 extends several feet to a head 17 opposite approximately end 15. Head 17 is normally a component that is attached to tube 13, but it could be integrally formed thereon. A nozzle 19 (FIG. 4) extends from head 17 for dispensing viscous material onto an application surface. Nozzle 19 is a few inches wide and has a width greater than its height.

Referring again to FIG. 1A, a piston 21 is sealingly and slidingly carried in tube 13. A chamber 23 is defined on the forward side of piston 21 for containing a quantity of viscous material. In the preferred embodiment, the viscous material is one part or constituent of a wall board compound. A line or cable 25 extends from piston 21 in forward direction for pulling piston 21 along the length of tube 13 while the compound is being dispensed. Referring to FIG. 4, a reel or winch 27 is located within head 17. Cable 25 wraps around reel 27 so that rotation of reel 27 will advance piston 21 in a forward direction.

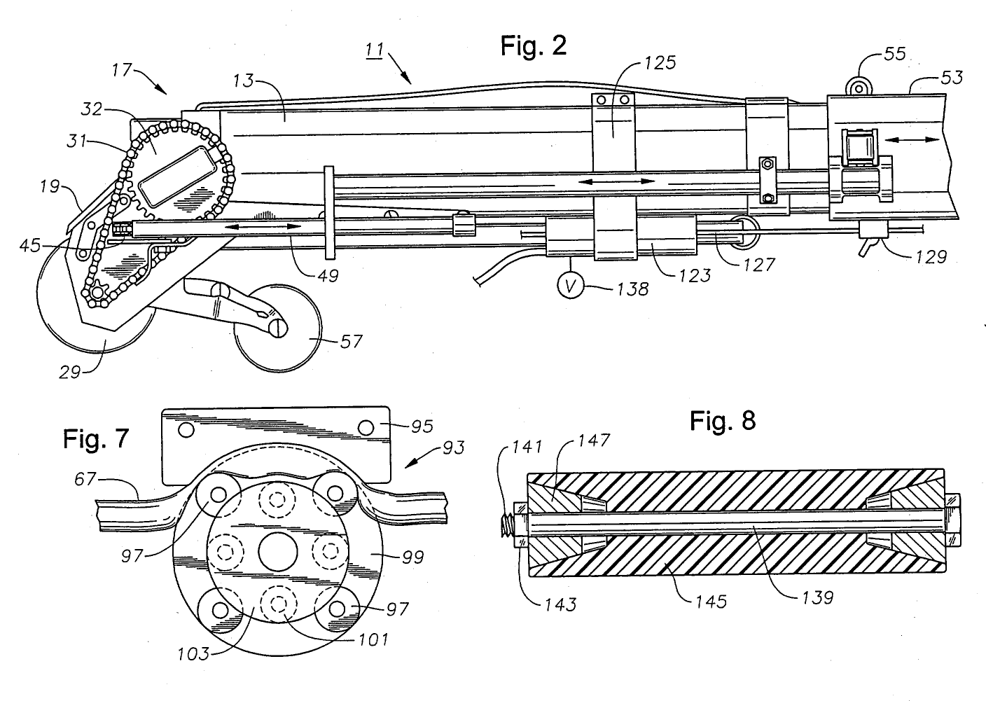

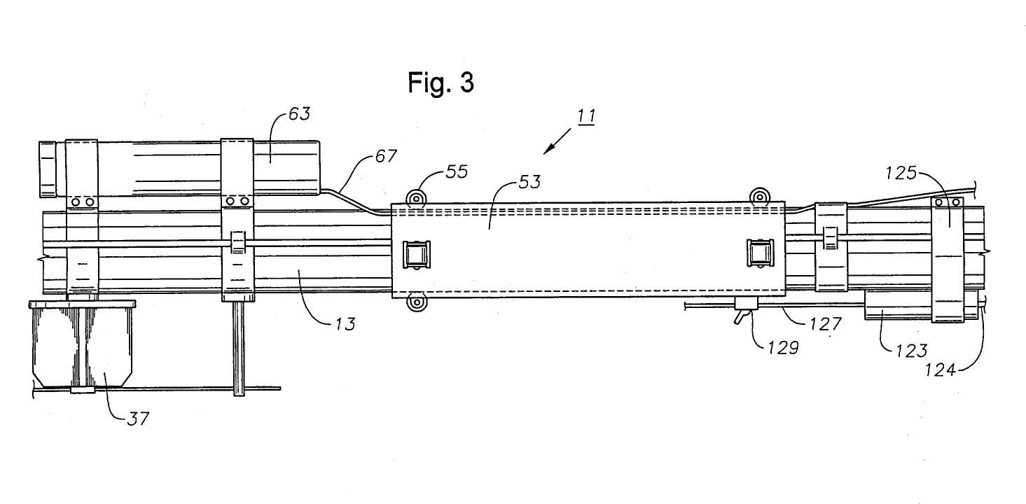

Reel 27 is rotatably driven by a wheel 29 rotatably mounted to head 17, as shown in FIG. 1B. Wheel 29 has serrated edges for engaging an application surface such as wall board. As head 17 is moved along the application surface, wheel 29 will rotate. Wheel 29 is connected to a linkage comprising a chain 31 (FIG. 2) that rotates a sprocket 32. Sprocket 32 is connected to a drive shaft (not shown) that rotates reel 27 (FIG. 4).

A filler port 33 is located at head 17 for filling chamber 23 with viscous material, such as the first constituent of a board compound. Filler port 33 is a tube with a check valve 35 within it to prevent backflow from chamber 23. When compound is introduced under pressure through filler port 33, it will force piston 21 toward the rearward end 15 of tube 13, and line 25 will unwind from reel 27.

Referring to FIG. 1A, dispensing tool 11 also has a tape holder 37 for holding a supply of wall board tape 39 (FIG. 4). A roll of tape 39 locates on tape holder 37, with a web of tape 39 extending along the length of tube 13 and exiting over wheel 29 as shown in FIG. 4.

A cutter 41, illustrated schematically in FIG. 1B, will transversely cut tape 39 (FIG. 4) when the painter reaches the end of his stroke. Cutter 41 comprises a blade that moves transversely across tape 39. Cutter 41 is attached to a cutter chain 43 on one side, which in turn is connected to a spring 45. Spring 45 is located within a stationary mounted tube 47 and has one end secured to tube 47. As shown in FIG. 2, chain 43 is connected to an axially movable tube 49 on the opposite side. Movable tube 49 is connected by a link rod 51 to external sleeve 53. External sleeve 53 surrounds tube 13 and can be manually reciprocated in an axial direction. Rollers 55 mounted to sleeve 53 engage tube 13 to reduce friction and facilitate the axial movement. When the painter reciprocates sleeve 53, it will pull movable tube 49 and chain 43, causing cutter 41 (FIG. 1B) to move transversely across tape 39 to cut it.

Tool 11 also has a conventional tape advance mechanism 56, illustrated in FIG. 4. Tape advance mechanism 56 has a prong (not shown) that engages tape 39 (FIG. 4). Tape advance mechanism 56 strokes in unison with sleeve 53 to advance tape 39 after it is cut.

Referring again to FIG. 1B, tool 11 may optionally have a corner wheel 57. Corner wheel 57 is a conventional member that is pivotally mounted to head 17 for engaging the tape and pressing the tape into corners. Corner wheel 57 is actuated to its operational position (not shown) by a cable 59. Cable 59 leads to a lever 61, shown in FIG. 1A.

In the preferred embodiment, a catalyst reservoir 63 is mounted to tube 13 by a strap 65 as shown in FIG. 1A. Reservoir 63 holds a second constituent of a viscous material for being dispensed from tool 11, such as a drying catalyst for wall board compound. Reservoir 63 may have an internal piston (not shown) to provide a positive pressure on a flexible outlet tubing 67. The internal piston is biased by an internal spring toward the forward end of reservoir 63.

Tubing 67 leads to an inlet of a blender 69 as shown in FIG. 4. Blender 69 also has an inlet 71 for receiving compound from chamber 23. Inlet 71 and the inlet into blender 69 from flexible tubing 67 could be at the same place. Blender 69 mixes the catalyst with the compound, and the mixture flows out an outlet 73 that registers with nozzle 19. Inlet 71 has a check valve (not shown) for preventing flow from blender 69 into chamber 23 or flexible tubing 67. Outlet 73 has a check valve (not shown) for preventing back flow.

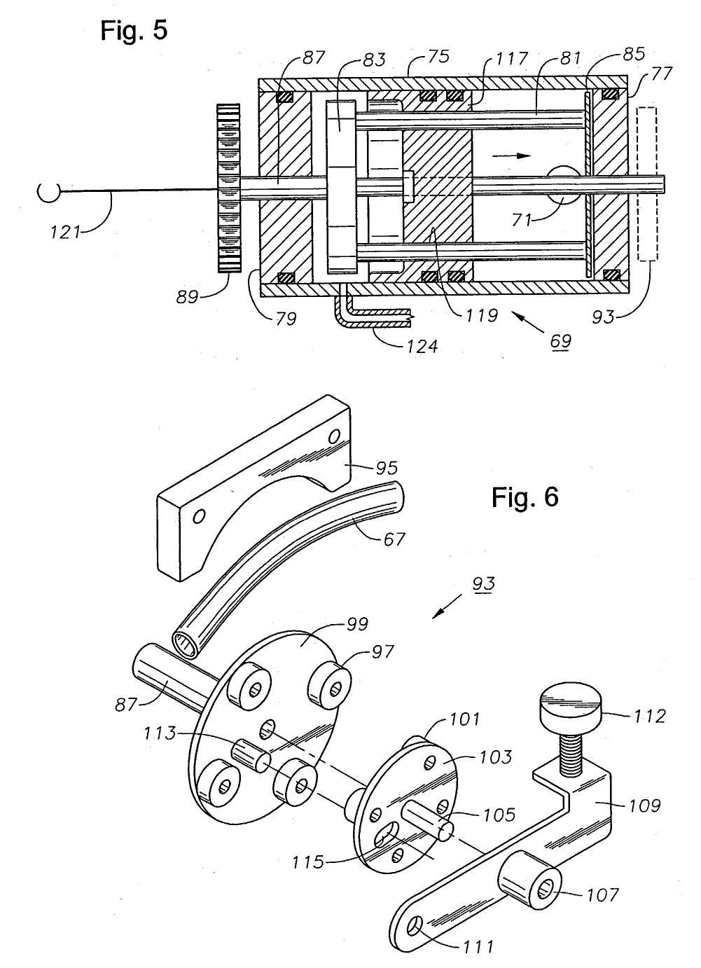

Referring to FIG. 5, blender 69 has a cylindrical housing 75, with the axis of housing 75 being perpendicular to the axis of tube 13 (FIG. 1B). Housing 75 includes two end walls 77, 79 on opposite ends. A rotary member comprising a plurality of stirring members or rods 81 is located inside. Rods 81 may be a variety of shapes, including flat or blade-shaped, and are mounted between flanges 83 and 85. Rods 81 are parallel to each other and spaced equally around a drive shaft 87. A sprocket 89 is driven by a chain 91 (FIG. 4) to cause rods 81 to rotate about the axis of housing 75 along drive shaft 87. Chain 91 is shown schematically in FIG. 4, and not shown in the other figures. Chain 91 is driven by wheel 29 simultaneously with reel 27. It is possible for reel 27 and blender 69 to be placed side-by-side, rather than fore and aft as shown, in which case they could be coaxial and driven by a single chain 31. Also, rather than one rod 81 at each location, there could be two or more rods at each location. These rods could be mounted to planetary gears driven by ring gear to further enhance mixing. The rods within each pair would revolve around each other as reel 27 rotates.

Referring to FIG. 7, a pump 93 is preferably employed to pump catalyst through flexible tubing 57 to blender 69 (FIG. 4). Pump 93 is preferably a peristaltic type having a stationary guide 95 with an arcuate portion against which tubing 67 will lie. Pump rollers 97 are mounted to a rotatable roller plate 99. Rollers 97 are spaced in a circular array around an axis of rotation of plate 99. Rotation of plate 99 causes each roller 97 to cyclically pinch tubing 67 against the arcuate surface of guide 95, pushing a volume of catalytic fluid in a forward direction. At least one of the rollers 97 will always be in engagement with tubing 67 to prevent any flow in tubing 67 unless plate 99 is rotated.

Optionally, a mechanism may be employed to vary the volume of fluid being dispensed through pump 93. In this embodiment, this includes a set of adjustment rollers 101. Each roller 101 is rotatably mounted to an adjusting plate 103. Rollers 101 are located between the pump rollers 97. Adjusting plate 103 has a pin 105 that rotatably inserts into a hub 107. Hub 107 is integrally formed with a lever 109. Lever 109 has a pivot point on one end and an adjusting screw 112 on the other end. Rotating adjusting screw 112 will move pin 105 and the axis of rotation of adjusting plate 103 relative to the axis of rotation of roller plate 99. Adjusting plate 103 is thus eccentrically mounted relative to roller plate 99. An eccentric pin 113 extends from roller plate 99 and engages an elongated slot 115 in adjusting plate 103 to cause rotation of adjusting plate 103 as roller plate 99 rotates.

As adjusting plate 103 moves to different positions by rotating adjusting screw 112, its adjusting rollers 101 are positioned closer to or farther from the guide surface of tubing guide 95. At least one of the volume rollers 101 can be positioned to contact and constrict tubing 67 between two of the pump rollers 97 to restrict the flow of the volume through tubing 67. Other types of adjusting devices are also feasible for varying the flow rate.

Referring to FIG. 5 again, a purge member 117 is preferably employed with blender 69 to purge it of all of its contents when the operator decides to cease use of dispensing tool 11. In this embodiment, purge member 117 comprises a piston that is moveable from end wall 79 toward end wall 77 to purge the interior of housing 75 of its contents. The mixed fluid will flow out outlet 73 (FIG. 4). Outlet 73 (FIG. 4) is located adjacent wall 77 in this embodiment. Purge piston 117 has holes 119 through which each of the rods 81 and drive shaft 87 slidingly pass.

Purge piston 117 could be manually pulled from one end plate 79 to the other end plate 77, then pulled back if desired. A cable 121 is shown connected to purge piston 117 for pulling it back to the end plate 79. In this embodiment, however, purge piston 117 is driven toward end plate 77 by hydraulic fluid pressure and retracted by cable 121. The hydraulic fluid pressure in this embodiment is provided by a hydraulic reservoir 123, shown in FIG. 2. Hydraulic reservoir 123 is secured by a strap 125 to tube 13 near head 17. Hydraulic reservoir 123 contains hydraulic fluid, which is pumped out a hydraulic fluid line 124 that leads to housing 75 of blender 69 (FIG. 4). An internal piston with a plunger 127 extending therefrom is located within hydraulic reservoir 123. Plunger 127 is a rod that extends rearward alongside external sleeve 53. A latch 129 is mounted to sleeve 53 for slidingly receiving plunger 127. When latch 129 is placed in a locking position, it will cause plunger 127 to move in unison with sleeve 53. When placed in a released position, sleeve 53 can be reciprocated axially without moving plunger 127. In this manner, when the operator wishes to stop using tool 11, he will flip latch 129 to the locked position, then reciprocate sleeve 53 to deliver hydraulic fluid to piston 117 (FIG. 5) to purge blender 69. Sleeve 53 will simultaneously actuate cutter 41 (FIG. 1B).

Referring to FIG. 4, the main piston 21 for chamber 23 optionally may have a plunger 131 mounted thereon and protruding in a forward direction. An inlet tube 131 extends from blender inlet 71 into chamber 23. At the conclusion of the stroke of piston 21, plunger 131 enters inlet tube 133 and forces any remaining compound in tube 133 into inlet 71 of blender 69. However, since compound in chamber 23 has not yet mixed with catalyst, it is not necessary to purge chamber 23 and inlet tube 133 unless tool 11 is to be stored for a lengthy time.

Referring still to FIG. 4, since nozzle 19 will contain compound mixed with catalyst, it is preferable to purge it also of the mixture during periods of non-use that exceed the curing time for the mixture. In the preferred embodiment, the purge member includes a bladder 135 that is mounted to one side of nozzle 19. Bladder 135 is secured at its forward and rearward ends and side edges, however the portion within its perimeter is free to distend as indicated by the dotted lines, when supplied with hydraulic fluid pressure through tubing 137. Bladder 135 will extend over into contact with the opposite side of nozzle 19.

Since blender housing 75 purges its contents into nozzle 19, the purging must be sequential. Blender housing 75 must be purges before nozzle 19. This could be handled by a two way valve 138 that selectively delivers hydrualic fluid pressure to line 124 (FIG. 2) that leads to purge piston 117 (FIG. 5) or to a line 137 is also connected with hydraulic reservoir 123 (FIG. 2). Alternately, a separate piston (not shown) could be mounted in blender housing 75 (FIG. 5) that is contacted by purge piston 117 near the conclusion of its stroke. The separate piston would deliver hydraulic fluid pressure into line 137 at piston 117 completes its stroke.

It may be desirable to vary the rate at which the compound is dispensed relative to rotation of wheel 29 (FIG. 4). This is handled by increasing or decreasing the speed at which piston 21 moves relative to the rotation of wheel 29. In the preferred embodiment, as shown in FIG. 8, reel 27 is rotatably mounted on a rod 139 that has threads 141 and a nut 143 on one end. Reel 27 includes an expansible mandrel or drum 145 that is mounted on rod 139. Drum 145 is preferably of an elastomeric material that when deformed will expand radially outward. It may have one or more slits, (not shown) to facilitate expansion. Cones 147 are mounted within conical recesses at the ends of drum 145 for decreasing the length of drum 145 and thereby causing radial expansion when nut 143 is tightened. Increasing the diameter of drum 145 will increase the speed of piston21 relative to wheel 29.

In operation, the user fills compound in chamber 23 by injecting the compound under pressure into inlet 33, as shown in FIG. 4. This causes chamber 23 to fill and piston 21 to retract to the proximal end as shown in FIG. 1A. The user fills catalyst reservoir 63 with catalyst mixture. The user makes sure that hydraulic fluid is contained hydraulic reservoir 123 (FIG. 1B). The user draws a web of tape 39 past wheel 29 as shown in FIG. 4.

The user then places wheel 29 against a wall surface with tape 39 located between wheel 29 and the wall surface. The user then begins advancing head 17 along the wall surface. This causes wheel 29 to rotate, pulling tape 39 from the supply roll and pressing tape 39 against the wall surface, which is normally a joint between the wall boards. When wheel 29 rotates, it rotates different components of the tool. It rotates reel 27 (FIG. 4) to cause piston 21 to move toward the forward end, pushing compound into tube 133. The rotation of wheel 29 also rotates blender 69, which receives compound from chamber 23. The rotation of wheel 29 also drives pump 93 (FIG. 7), delivering catalyst from catalyst chamber 63 (FIG. 1B) to blender 69. Blender 69 mixes the catalyst with the compound and dispenses the mixture out nozzle 19. Compound flows onto the tape and the wall surface as wheel 29 moves.

When the operator reaches the end of the stroke, he will reciprocate sleeve 53 (FIG. 1B), causing cutter 41 to cut tape 39. If the operator intends to immediately make another stroke with tool 11, he will make sure that latch 129 is in the released position, so that purge hydraulic fluid will not be delivered from hydraulic cylinder 123. When the operator completes a task that will result in the tool not being used for a time period that is beyond the curing time for the mixed compound, he will purge blender 69 and nozzle 19 of the mixed compound. The operator does this by flipping latch 29 to the locked position and reciprocating sleeve 53. The movement of sleeve 53 causes piston plunger 127 to move in unison with sleeve 153. This causes hydraulic pressure to flow to purge piston 117 of blender 69, as shown in FIG. 5. Purge piston 117 will transverse from end wall 79 to end wall 77, expelling all of the compound out outlet 73 of housing 75 into nozzle 19. The operator returns piston 177 back to its initial position by pulling on cable 121. The operator changes the position of valve 138 (FIG. 2) and again strokes sleeve 53 to cause hydraulic fluid pressure to be deliver to bladder 135 to purge nozzle 19 of mixed compound. Bladder 135 will deform to the position shown by the dotted lines 136, expelling the mixed compound from nozzle 19. Unless dispensing tool 11 is not to be used for a lengthy time, the remaining compound in chamber 23 may remain in chamber 23. Also, the remaining catalyst in catalyst reservoir 63 may remain therein.

The invention has significant advantages. The tool allows a user to dispense a compound that is mixed with a catalyst to reduce the time for drying. The invention also has features to purge itself of mixed compound at the end of each use to avoid clogging the tool. The tool is adjustable to vary the flow of catalyst and vary the flow of compound.

While the invention has been shown in only one of its forms, it should be apparent to those skilled in the art that it is not so limited but it is susceptible to various changes without departing from the scope of the invention. For example, although the tool described is used for dispensing a wall board compound, it has other uses.

1. An apparatus for dispensing a viscous material having first and second constituents, comprising:
a handheld elongated member having a nozzle on one end; and
a blender carried by the elongated member adjacent the nozzle, the blender having an inlet for receiving a first constituent from a first constituent source and a second constituent from a second constituent source, the blender having a rotary member for mixing the first and second constituents, the blender having an outlet leading to the nozzle for dispensing the blended first and second constituents.

2. The apparatus according to claim 1, wherein the rotary member of the blender comprises:
a plurality of stirring members extending between two flanges, the stirring members being spaced around an axis of rotation that passes through the flanges, the flanges being rotatably driven.

3. The apparatus according to claim 1, wherein the rotary member of the blender comprises:
a plurality of stirring members extending between two flanges, the stirring members being spaced in an array around an axis of rotation that passes through the flanges, the flanges being rotatably driven; and wherein the blender further comprises:
a housing surrounding the stirring members, the inlet and outlet of the blender being located in the housing.

4. The apparatus according to claim 1, wherein the rotary member of the blender comprises:
a plurality of parallel stirring members extending between two flanges, the stirring members being spaced in an array around an axis of rotation that passes through the flanges, the flanges being rotatably driven; and wherein the blender further comprises:
a housing surrounding the stirring members, the inlet and outlet of the blender being located in the housing; and
a purge piston located within the housing and sealingly and slidingly engaging an inside surface of the housing, the purge piston having a plurality of holes for slidingly receiving each of the stirring members, the purge piston being selectively movable along the axis of rotation from one of the flanges to the other for purging an interior of the housing of the first and second constituents when the apparatus ceases operation.

5. The apparatus according to claim 1, wherein the second constituent source comprises:
a second constituent reservoir carried by the elongated member;
a flexible tubing leading from the second constituent reservoir to the inlet of the blender;
a peristaltic pump mounted to the elongated member, the pump having a pinch roller and a tubing guide, between which the flexible tubing extends, the pinch roller being rotated into and out of engagement with the tubing to pump the second constituent from the second constituent reservoir to the inlet of the blender.

6. The apparatus according to claim 1, further comprising:
a hydraulically actuated purging member located in the nozzle for selectively purging the nozzle of the viscous material when the apparatus ceases operation.

7. The apparatus according to claim 1, further comprising:
a wheel rotatably mounted to the end of the elongated member for engaging a wall surface and rotating as a user traverses the wheel along the wall surface; and
a drive link connected between the wheel and the blender for driving the blender as a result of rotation of the wheel.

8. The apparatus according to claim 1, wherein the first constituent source comprises:
an elongated member piston sealingly and slidably carried in the elongated member, defining a chamber between the elongated member piston and the blender that is adapted to receive a quantity of the first constituent;
a reel located in the elongated member adjacent the blender;
a line extending from the piston and wrapped around the reel;
a wheel rotatably mounted to the end of the elongated member for engaging a wall surface and rotating as a user traverses the wheel along the wall surface; and
a reel drive link connected between the wheel and the reel for rotating the reel to advance the elongated member piston as the wheel rotates to move the first constituent toward the blender.

9. The apparatus according to claim 1, wherein the first constituent source comprises:
an elongated member piston sealingly and slidably carried in the elongated member, defining a chamber between the elongated member piston and the blender that is adapted to receive a quantity of the first constituent;
a reel located in the elongated member adjacent the nozzle;
a line extending between the piston and the reel;
a wheel rotatably mounted to the end of the elongated member for engaging a wall surface and rotating as a user traverses the wheel along the wall surface; and
a reel drive link connected between the wheel and the reel for rotating the reel to advance the elongated member piston to move the first constituent toward the blender; wherein the second constituent source comprises:
a second constituent reservoir mounted to the elongated member;
a second constituent pump in communication with the second constituent reservoir for delivering the second constituent to the blender, the second constituent pump also being driven in response to rotation of the wheel; and the apparatus further comprises:
a blender drive link connected between the wheel and the blender for driving the blender as a result of rotation of the wheel.

10. An apparatus for dispensing a viscous material having first and second constituents onto a wall surface, comprising:
a handheld elongated member having a nozzle on one end;
a wheel rotatably mounted to the elongated member adjacent the nozzle for engaging the wall surface and rotating in response to movement of the wheel along the wall surface;
a blender carried by the elongated member adjacent the nozzle, the blender having an inlet for receiving the first constituent from a first constituent source and a second constituent from a second constituent source, the blender having a rotary member for mixing the first and second constituents, the blender having an outlet leading to the nozzle for dispensing the blended first and second constituents; and
a drive link between the wheel and the blender for causing rotation of the rotary member in response to rotation of the wheel.

11. The apparatus according to claim 10, wherein the rotary member of the blender comprises:
a plurality of stirring members extending between two flanges, the stirring members being spaced in an array around an axis of rotation that passes through the flanges, the flanges being rotatably driven by the drive link; and wherein the blender further comprises:
a housing surrounding the stirring members, the inlet and outlet of the blender being located in the housing.

12. The apparatus according to claim 10, wherein the second constituent source comprises:
a second constituent reservoir carried by the elongated member;
a passage leading from the second constituent reservoir to the inlet of the blender; and
a pump mounted to the elongated member in communication with the passage and driven by rotation of the wheel to pump the second constituent from the second constituent reservoir to the inlet of the blender.

13. The apparatus according to claim 1, wherein the first constituent source comprises:
an elongated member piston sealingly and slidably carried in the elongated member, defining a chamber between the elongated member piston and the blender that is adapted to receive a quantity of the first constituent;
a reel located in the elongated member adjacent the blender;
a line extending between from piston and wrapped around the reel;
a wheel rotatably mounted to the end of the elongated member for engaging a wall surface and rotating as a user traverses the wheel along the wall surface; and
a reel drive link connected between the wheel and the reel for rotating the reel to advance the elongated member piston as the wheel rotates to move the first constituent toward the blender.

14. The apparatus according to claim 10, further comprising:
a purge member located within the blender, the purge member being selectively movable in response to hydraulic pressure to expel first and second constituents from the blender when the apparatus ceases use.

15. The apparatus according to claim 10, further comprising:
a blender purge member located within the blender; and
a nozzle purge member within the nozzle, the blender and nozzle purge members being selectively movable in response to hydraulic pressure to expel first and second constituents from the blender and the nozzle when the apparatus ceases use.

16. The apparatus according to claim 10, further comprising:
a purge member located within the blender, the purge member being selectively movable in response to hydraulic pressure to expel first and second constituents from the blender when the apparatus ceases use;
a tape holder mounted to the elongated member for holding a roll of tape, a web of the tape adapted to extend to the end of the elongated member for dispensing onto a wall surface;
a cutter mounted to the head, the cutter being movable transverse to an axis of the elongated member for severing the web of tape after it has been dispensed onto the wall surface;
a sleeve carried on the elongated member for axial reciprocal movement, the sleeve being linked to the cutter for moving the cutter in response to axial movement of the sleeve; and
a hydraulic cylinder having a plunger that is selectively engageable with the sleeve, the hydraulic cylinder being in fluid communication with the purge member, such that axially moving the sleeve delivers hydraulic pressure to the purge member when the plunger is in engagement with the sleeve.

17. In an apparatus for dispensing a viscous material and a tape onto a wall surface, having a tubular elongated member with a nozzle on one end, a wheel rotatably mounted to the elongated member adjacent the nozzle for engaging the wall surface and rotating in response to movement of the wheel along the wall surface, an elongated member piston sealingly and slidably carried in the elongated member, a first constituent chamber between the elongated member piston and the nozzle that is adapted to receive a quantity of a first constituent of the viscous material, a reel located in the elongated member adjacent the nozzle, a line extending between from the piston and wrapped around the reel, the reel being driven by rotation of the wheel, a tape holder mounted to the elongated member for holding a roll of tape that has a web that leads to the end of the elongated member for dispensing the tape onto the wall surface, a cutter mounted to the head for transverse movement to cut the web of tape, and a sleeve carried around the elongated member for axial reciprocal movement to move the cutter, the improvement comprising:
a reservoir mounted to the elongated member for holding a quantity of a second constituent;
a blender carried by the elongated member adjacent the nozzle, the blender having an inlet for receiving the first constituent from the first constituent chamber and for receiving the second constituent from the reservoir, the blender having a rotary member for mixing the first and second constituents, the blender having an outlet leading to the nozzle for dispensing the blended first and second constituents;
a pump located between the reservoir and the blender for pumping the second constituent to the inlet of the blender; and
the pump and the rotary member of the blender bing operationally linked to the wheel such that movement of the wheel drives the pump and rotates the rotary member.

18. The apparatus according to claim 17, wherein the rotary member of the blender comprises:
a plurality of stirring members extending between two flanges, the stirring members being spaced in an array around an axis of rotation that passes through the flanges, the flanges being rotatably driven by the drive link; and wherein the blender further comprises:
a housing surrounding the stirring members, the inlet and outlet of the blender being located in the housing.

19. The apparatus according to claim 17, further comprising:
a purge member located within the blender, the purge member being selectively movable in response to hydraulic pressure to expel first and second constituents from the blender when the apparatus ceases use;
a hydraulic cylinder having a plunger that is selectively engageable with the sleeve, the hydraulic cylinder being in fluid communication with the purge member, such that axially moving the sleeve delivers hydraulic pressure to the purge member when the plunger is in engagement with the sleeve.

20. The apparatus according to claim 17, further comprising:
a blender purge member located within the blender, the blender purge member being selectively movable in response to hydraulic pressure to expel first and second constituents from the blender when the apparatus ceases use;
a nozzle purge member located within the nozzle, the nozzle purge member being selectively movable in response to hydraulic pressure to expel mixed first and second constituents from the nozzle when the apparatus ceases use; and
a hydraulic cylinder having a plunger that is selectively engageable with the sleeve, the hydraulic cylinder being operatively connected with the blender and nozzle purge members, such that axially moving the sleeve delivers hydraulic pressure to the purge members when the plunger is in engagement with the sleeve.

21. The apparatus according to claim 20, wherein the reel has a hub onto which the line is wrapped, the hub having a variable diameter to vary the rate at which the line is wrapped thereon.

22. A method for dispensing a viscous material having first and second constituents, comprising:
(a) providing a handheld elongated member having a nozzle on one end;
(b) mounting a blender to the elongated member adjacent the nozzle, the blender having a rotary member for mixing the first and second constituents;
(c) grasping the elongated member, positioning the nozzle on an application surface, then flowing first and second constituents to the blender;
(d) rotating the rotary member of the blender to mix the constituents; then
(e) flowing the mixed constituents from the blender to the nozzle and dispensing the mixed constituents onto the application surface.

23. The method according to claim 22, wherein step (a) further comprises:
mounting a wheel to the end of the elongated member adjacent the nozzle and operatively linking the wheel to the rotary member of the blender; and
step (d) comprises moving the wheel along the application surface to rotate the wheel, and causing the rotary member to rotate in response to the rotation of the wheel.

24. The method according to claim 22, wherein step (a) further comprises:
providing a chamber in the elongated member and placing a quantity of the first constituent in the chamber, the chamber being in communication with the inlet of the blender;
placing a piston in the chamber on an end of the chamber opposite the blender;
mounting a second constituent reservoir to the elongated member;
mounting a pump to the elongated member, the pump having an inlet operatively connected with the second constituent reservoir and an outlet operative connected to the inlet of the blender;
mounting a wheel to the end of the elongated member adjacent the nozzle and operatively linking the wheel to the piston, the pump and to the rotary member of the blender; and
step (d) comprises moving the wheel along the application surface to rotate the wheel, and in response thereto, causing the piston to move the first constituent to the blender, the pump to deliver the second constituent to the blender, and the rotary member to rotate.
